(19) United States
(12) Patent Application Publication
(10) Pub. No.: US 2010/0324933 A1
(43) Pub. Date: Dec. 23, 2010

(54) Sequential Timing and Alarm System for Tracking Operating Room Procedures in Prevention of Wrong Site Surgery

(76) Inventor: Brandon Giap, San Diego, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/488,896

(22) Filed: Jun. 22, 2009

(51) Int. Cl. G06Q 50/00; G06F 17/00

(52) U.S. Cl. 705/3; 705/2; 705/30

(57) ABSTRACT

An operating room procedure tracking device for tracking patients in surgery. The device employs a processor and user activated sequential switches to track the progress of the patient from their entry into the operating room to their departure. A time out protocol is tracked as well as the duration of the patient in the surgery as well is in the operating room.

### BACKGROUND OF THE INVENTION

1. Field of the Invention

The invention herein disclosed relates to surgical procedures. More particularly, it relates to a device and method for sequentially tracking and recording events occurring during a surgical procedure and which encourages the following of proper procedural steps by the medical staff in the operating room to prevent wrong site surgeries.

2. Prior Art

### BACKGROUND OF THE INVENTION

Surgical procedures are a common occurrence in virtually every hospital throughout the world. Modern medicine and such procedures have provided mankind with such surgical procedures to treat patients in need of surgery for a particular problem.

Most surgical centers have a process to track use of the operating room for proper billing and for scheduling purposes. This includes tracking the entry time of the patient in the room, the start of surgery, the end time of surgery, and the time the patient leaves the operating room. Additionally, new safety protocols require that after a patient enters the room, but before surgery starts, that a time period be observed for the entire operating staff to confirm certain information for patient safety to prevent mistakes.

Such preventable problems occur during such surgeries and can be devastating to the patient and surgical staff alike. One well-publicized problem occurs when a surgery is conducted on the wrong site on the patient. For instance in an amputation procedure, due to an illness such as bone cancer, the surgical staff removes the right leg which is perfectly healthy, instead of a diseased left leg of a patient. The patient is devastated physically, in that their second leg will still be amputated, and the surgical staff will suffer the anguish of knowing they have harmed a patient. This is in addition to the financial harm that the staff and hospital may suffer from an operation on the wrong surgical site. Another example of a preventable problem is where a surgery is performed properly, but on the wrong patient.

Currently, standards have arisen to provide healthcare facilities throughout the U.S. with protocols to prevent surgical mistakes. The Universal Protocol created by the Joint Commission on Accreditation of Healthcare Organizations was created to prevent wrong person, wrong procedure, wrong site surgery in hospitals and outpatient settings.

The Universal Protocol consists of three steps:
1. A preoperative/pre-procedure verification process.
2. Marking the operative/procedure site, and
3. A documented Time Out period where the entire operating room staff, meets and conforms with each other which is performed immediately before starting the operation/procedure wherein the entire operating staff ascertains that it is the correct patient, the correct operation, and the correct site on the patient, and any other issues of concern to providing the correct procedure to the correct patient.

Conventionally, prior to the patient entering the operation room, a responsible person on the operating room team, ensures that all documents are examined as to the patient identity and upcoming procedure, prior to the start of the procedure. Missing information and/or discrepancies must be addressed before the start of the procedure. This verification includes proper written patient identification, a signed consent, a marker on the surgical site identifying it, and any other information required by the medical facility.

Once the patient enters the room, the time is noted on a chart. Currently this is widely done by hand with a pen or pencil by one of the team in the room.

Prior to the start of surgery, the Time Out must be observed and documented as having been observed. During this time out, there is a deliberate pause in activity, and everyone in the room participates in a clear communication which at least is to include: active listening to each other, a verbal confirmation of the proper patient, the proper procedure, and the proper surgical site. All members of the surgical/procedural team participate and are informed and agree as to the information presented. The procedure is not started until any questions or concerns are resolved amongst all team members.

The Time Out period must be documented and includes verifying at least, that it is the correct patient, that the team is following the correct procedure and has a consent. That the team is in agreement on the correct site and the site is marked, that the patient is placed in the proper position, and the availability of correct implants and any special equipment or requirement.

Once the Time Out period is over, this must be documented for the record, which is again done by hand conventionally. Thereafter the start time of the operation is documented, the end time, and the time the patient leaves the room.

All of these critical events, are conventionally tracked by handwriting them onto a chart or record. This is tedious, requires great detail, and since elapsed times and time stamps are the items being recorded, they can easily be forgotten or inaccurate should the person in charge of keeping the record be distracted or forget.

As such, there is an unmet need for a widely and easily employed device that will allow the surgical staff in an operating room to track and follow the sequential steps in a surgical procedure. Such a device and system should insure that the surgical staff follows the established medical protocol to insure that the subject of the operation is the correct patient, and the site of the operation is the correct site on the patient, and that the operation being performed, is in fact the proper procedure for that identified patient and surgical site. Further, such a system should provide tracking of the times and durations of the various segments of a surgical procedure from start to finish, to allow the hospital to properly bill for operating room time, and to allow schedulers to know when an operating room is available at the end of a procedure.

### SUMMARY OF THE INVENTION

The disclosed device and method provide a novel remedy to the noted shortcomings of implementing the proper surgical procedure protocols in a fashion that insures such protocols are followed in sequential steps to prevent wrong site surgery. The device also provides a remotely communicable time tracking system which will aid in record keeping and proper billing for the medical facility hosting the surgical procedure in an operating room.

The device features a housing adapted for hanging on a wall or stand. The device employs a sequentially placed plurality of bottons which may be illuminated and may also have audible alarms to make sure they are depressed to record timed events.

The buttons are preferably large in physical area to allow users to press them with an elbow or body part should they wish to keep their hands from touching an unsterile surface. Such an area would be at least four square inches and up to sixteen square inches if a four inch by four inch button were employed. An internal clock and software adapted to the task will maintain a running time from which any button depression may ascertain a time stamp for an event, or a total duration between events.

A first button would be provided which, when depressed, will display a time stamp next to it and allow the device using software to place the timestamp in memory or transmit it to a remote computer for record keeping. This first button records entry of the patient in the room.

A second button is provided to document a time stamp and duration for a time out. This second button would be depressed at the start of the time out and display a time stamp and store the time of the depression. The second button may have an audible alarm, visual alarm, or both, to remind the staff and the person responsible for keeping records that a time out has not yet occurred. The alarm can be timed to go off at a time subsequent to the first button depression to remind the staff to have a time out.

A third button records the end of the time out, and the start of surgery and a display may be provided for a time stamp. The start of surgery will be the end of the timeout and can be recorded to document the duration of the time out.

A fourth button is provided for depression when the operation ends to record a timestamp, and allow a calculation of the duration of the operation.

A fifth, sequentially arranged, button is depressed when the patient leaves the room, thereby documenting the awakening period for the patient and the total aggregate time since the patient came into the room.

A reset button is provided, preferably away from the sequentially placed buttons, to avoid an accidental depression resetting the device to zero.

The device would have operative electronics and microprocessors to run software adapted to the tasks above. Further, it would have a wired or wireless connection to a remote computer such that the stored data as to time stamps and durations can be transmitted and printed for record keeping and billing purposes. This automatic calculation, time stamping and transmission of notations relieves the staff person of the requirement for tedious and mistake prone notes. It also allows for easier operating room scheduling since software may keep track of the times the room becomes available and dispatch personnel to make it ready for the next surgical procedure and patient.

With respect to the above description, before explaining at least one-preferred embodiment of the device and method for sequentially tracking and monitoring surgical procedures to insure implementation of established protocols to prevent wrong site surgery invention in detail, it is to be understood that the invention is not limited in its application to the details of operation nor the arrangement of the components or steps set forth in the following description or illustrations in the drawings. The various methods of implementation and operation of the invention are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of other devices and systems for carrying out the several purposes of the disclosed method and device to insure that surgical protocols are followed. It is important, therefore, that the objects and claims be regarded as including such equivalent construction and methodology insofar as they do not depart from the spirit and scope of the present invention.

Further objectives of this invention will be brought out in the following part of the specification wherein detailed description is for the purpose of fully disclosing the invention without placing limitations thereon.

It is an object of this invention to assure a time out procedure is performed by a gathering of a surgical team prior to every surgical procedure and the surgery is well reviewed prior to beginning.

Another object of this invention is the provision of sequential visual cues to insure proper steps are followed in a surgical procedure.

An additional object of this invention is the provision of an audible alarm to alert the surgical staff in a surgical procedure and gain their attention for critical procedure junctures such as a time out assembly of the surgical staff.

An additional object of this invention is to aid the operating room staff members in time-marking of the occurrences of the significant events in the operating room.

A yet additional object of the invention is to provide time marks of events and aggregate duration of a surgical procedure to better record and more accurately bill hospital time charges.

A further object of the invention is the provision of ongoing viewable time-marks to keep the members of the surgical staff informed.

A still further object of this invention is the automatic recording of data about the steps and duration of a surgical procedure to aid the surgical staff and allow them more time for actual patient care.

These together with other objects and advantages, which become subsequently apparent, reside in the details of the construction and operation as more fully hereinafter described and claimed, reference being had to the accompanying drawings forming a part thereof, wherein like numerals refer to like parts throughout.

### BRIEF DESCRIPTION OF DRAWING FIGURES

FIG. 1 depicts a wall or stand mountable light board which automatically sequentially alerts the staff of the next time which must be documented.

FIG. 2 shows a remote computer adapted to receive data from the device and print it for the patient chart, forward it to accounting for billing, and to allow for notification of cessation of a surgical procedure.

FIG. 3 depicts a mode of the device for aiding the method herein wherein a clock and alarm are included.

### DETAILED DESCRIPTION OF THE PREFERRED EMBODIMENTS OF THE INVENTION

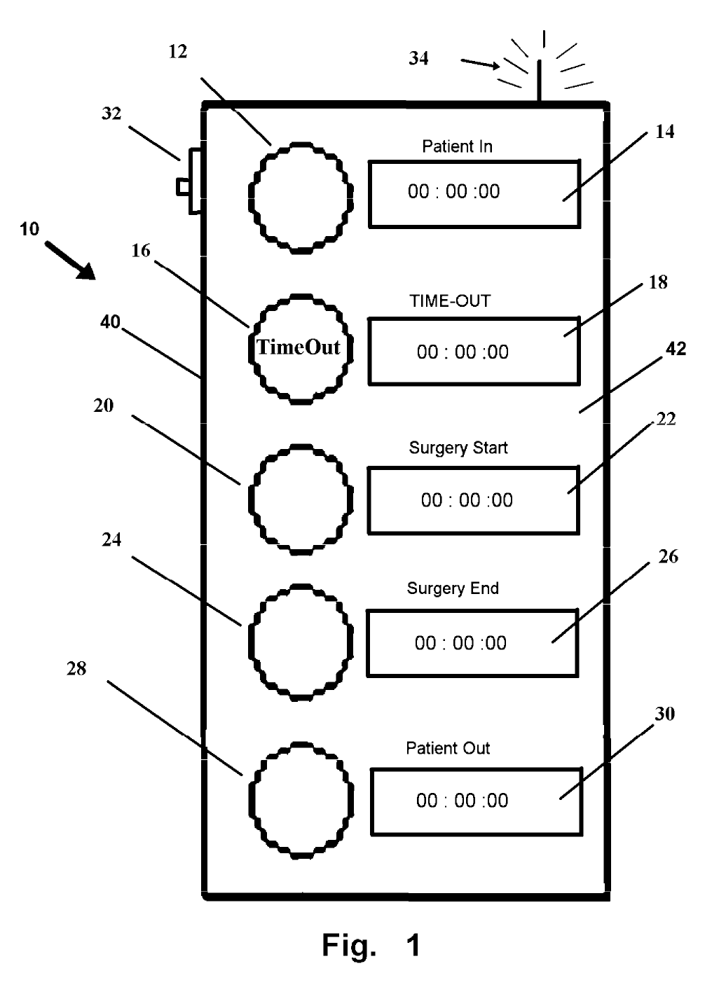

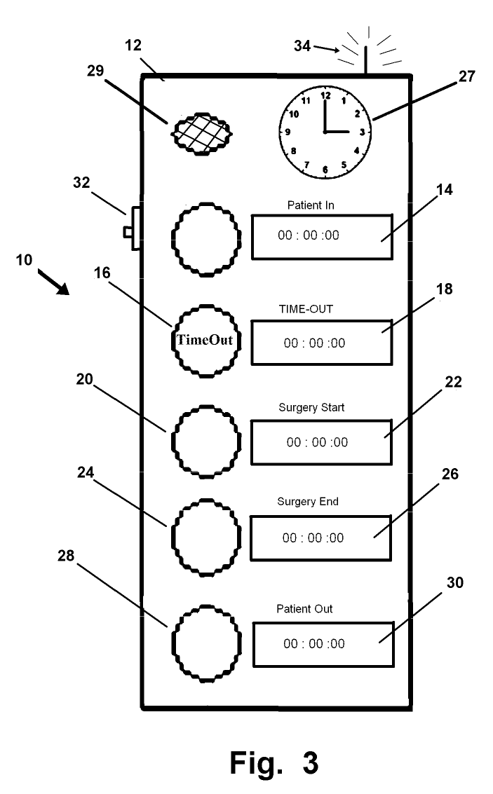

Referring now to the drawings in FIGS. 1-3 wherein similar steps and components are identified by like reference numerals, there is seen in FIG. 1, the disclosed on time or early payment encouragement system for cardholders disclosed herein.

The device 10 is shown with the sequentially arranged buttons operatively engaged with a housing which may be wall mounted and which may be illuminated or alarmed to remind operating room staff to perform the next step in the automatic process of record keeping of events in the room. While the term button is being used to describe user activated switches, any user activated switching means, be it mechanical or electronic and which will activate an electronic component or cause an microprocessor or relay to activate or deactivate electronic components on the device in a conventional fashion may be employed.

The first button 12 operatively positioned on the housing, is provided to docket the time of arrival of a patient for both medical records and for billing purposes and is depressed upon the patient entering the room. A time stamp 14 may be displayed next to it on a video display and the time may be held in memory on the device 10 and may be transmitted over a network to a record keeping software program for either the patient's chart or for accounting purposes to track and time presence in the operation room. Following the aforementioned procedure above of tracking the patient arrival, and concurrent with a member of the surgical team responsible for initiating it, the second button 16 is depressed to docket and signify the start of the time out. The second button 16, preferably will also initiate audible and/or visible alarms which will provide a means to remind the surgical staff to perform this time out function. A second timestamp display 18 may be provided for the start of the time out and the duration tracked and communicated over a network for billing and chart purposes by the depression of the third button 20.

The third button 20 is depressed at the start of surgery and a third time stamp display 22 may be provided to display that moment in the procedure. At the end of the duration of the surgery, a fourth button 24 is depressed and a fourth time stamp display 26 is illuminated with a time stamp of either the moment in time, or duration of the procedure, or both displayed. The duration of the surgery as defined by the time between the depression of the third button 20 and fourth button 24 can be stored in onboard memory and transmitted over a computer network for patient chart inclusion and for accounting purpose.

Once the patient leaves the operating room, a fifth button 28 is depressed and a fifth timestamp display 30 will display either the time of leaving or the duration between the end of the operation procedure, and the time of the patient leaving. This is important for accounting and record keeping also as the duration between the first button 12 depression and the fifth button 28 depression can be employed to track the total duration of the patient in the operating room for both patient charts and for accounting purposes for billing for time in the operating room.

Upon ascertaining the surgery is over and that the patient has left the operating room, a reset button 32 is depressed to reset the system. The reset button 32 is preferably placed in a position such as on a side surface 40 different from the front surface 42 where the other controls are located, where it is not accidentally depressed. This positioning thereby provides a means to reset the device 10 for the next patient, and which also prevents an accidental reset during a surgery. The reset button 32 may also have software engaged requiring activation for a duration of a few seconds or multiple times to reset the device as a safety measure. The device 10 as noted, may have network communications with remote computers and software through a conventional wired or a wireless 34 network communication.

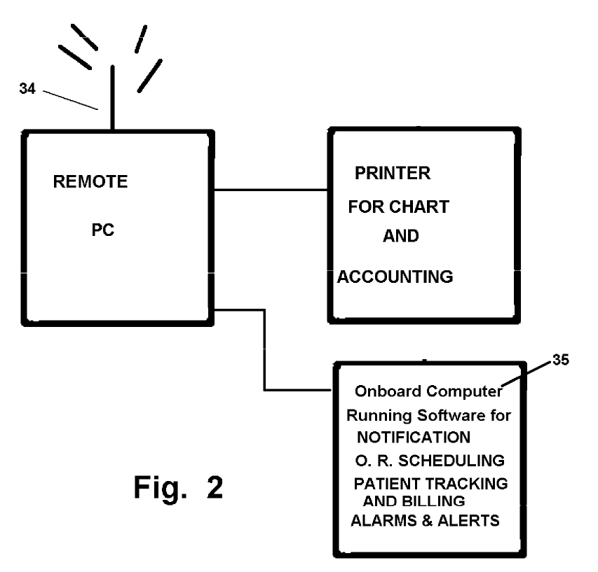

Data from the onboard computer 35 having a microprocessor and memory operationally engaged and powered onboard the device 10, and software operating thereon, will be transmitted over the network or directly to the remote computer for printing to the patient chart, for accounting purposes, and for operating room scheduling as depicted in FIG. 2. Transmission may be wireless or by wired network communications.

Additionally, in another preferred mode of the device 10 a clock 27 may be provided to allow users to see the real time. Also, an alarm 29 may be provided which is sonic or visual, such as a blinking light, or both. The alarm is activated by the software running on the device 10 to alert the staff in the operating room to pay attention during the time out period or for other reasons.

The device 10 is depicted in the mode with most utility however it may be provided with less buttons and function and still track the time out period and concurrently alert the operating room team of the time out period. This could be done by simply having the time out button and an internal data processor to track the time duration and to initiate an visual or audible alarm during that period.

While all of the fundamental characteristics and features of the method and device shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. An operating room procedure apparatus for tracking patients in an operating room, comprising:
a housing operatively engageable to electrical power;
a microprocessor operatively powered by said electrical power;
a user-activated first means for switching;
an activation of said first means for switching upon a patient entering said operating room causing said microprocessor to ascertain a first time point;
a user activated second means for switching;
an activation of said second means for switching causing one or both of an audio or visual alarm to activate for an alarm duration;
a user activated third means for switching;
an activation of said third means for switching causing an end to said alarm duration;
a user activated means to reset said microprocessor to monitor for said activation of said first means for switching; and
whereby said patients arrival time into said operating room is noted by said activation of said first means for switching, and a time out period is initiated by said activation of said second means for switching and ended with said activation of said third means for switching.

2. The operating room procedure apparatus of claim 1, additionally comprising:
said microprocessor engageable to a network and in communication with a remote computer;
said microprocessor having software thereon adapted for time tracking and communication to said remote computer;
said first time point communicable over said network to said remote computer;
said activation of said second means for switching causing a second time point to be ascertained by said microprocessor;
said activation of said third means for switching causing a third time point to be ascertained by said microprocessor;
a time out duration ascertainable by the difference between said second time point and said third time point and communicable over said network to said remote computer, whereby a time of patient entry to said operating room represented by said first time point, is communicable to said remote computer, and said time out occurrence, and a duration for said time out occurrence is communicable to said second computer wherein it may be employed for patient and accounting records.

3. The operating room procedure apparatus of claim 2, additionally comprising:
a first clock display on said housing, said first clock display displaying said first time point subsequent to activation of said first means for switching;
a second clock display on said housing, said second clock display displaying said second time point subsequent to said activation of said second means for switching;
a third clock display on said housing, said third clock display displaying said third time point subsequent to said activation of said third means for switching, whereby said first time point representing said patient's arrival and said second time point representing a start of said time out and said third time point representing a start of surgery on said patient are all visually displayed for occupants of said operating room.

4. The operating room procedure apparatus of claim 3, additionally comprising:
a user-activated fourth means for switching; and
an activation of said fourth means for switching at an end time of said surgery determining a fourth time point and allowing for a surgery duration to be determined by the difference between said third time point and said fourth time point.

5. The operating room procedure apparatus of claim 4, additionally comprising:
a fourth clock display on said housing, said fourth clock display displaying said fourth time point subsequent to said activation of fourth means for switching.

6. The operating room procedure apparatus of claim 4, additionally comprising:
a user-activated fifth means for switching; and
an activation of said fifth means for switching upon a departure of said patient from said operating room, determining a fourth time point;
a total duration of said patient's presence in said operating room determinable by the difference between said first time point and said fifth time point.

7. The operating room procedure apparatus of claim 4, additionally comprising:
a fifth clock display on said housing, said fifth clock display displaying said fifth time point subsequent to said activation of fifth means for switching.

8. The operating room procedure apparatus of claim 4, additionally comprising:
said surgery duration and said total duration of said patient's presence in said operating room are automatically communicated to said remote computer for inclusion said patient's records or for employment for billing purposes.

9. The operating room procedure apparatus of claim 2, additionally comprising:
a real time clock display on said housing.

10. The operating room procedure apparatus of claim 3, additionally comprising:
a real time clock display on said housing.

11. The operating room procedure apparatus of claim 5, additionally comprising:
a real time clock display on said housing.

12. The operating room procedure apparatus of claim 7, additionally comprising:
a real time clock display on said housing.

13. The operating room procedure apparatus of claim 8, additionally comprising:
a printer operatively engaged to one of said microprocessor or said remote computer, said printer printing records for inclusion in said patient's record or for accounting purposes.
